(19) United States
(12) Patent Application Publication
(10) Pub. No.: US 2013/0153252 A1
(43) Pub. Date: Jun. 20, 2013

(54) IMPACT TIGHTENING TOOL

(71) Applicant: Masahito Sakakibara, Okazaki-shi (JP)

(72) Inventor: Masahito Sakakibara, Okazaki-shi (JP)

(73) Assignee: TOYOTA JIDOSHA KABUSHIKI KAISHA, Aichi-ken (JP)

(21) Appl. No.: 13/819,200

(22) PCT Filed: Aug. 25, 2011
(86) PCT No.: PCT/IB2011/001950

§ 371 Date: Feb. 26, 2013

(30) Foreign Application Priority Data
Aug. 26, 2010 (JP) 2010-189732

(51) Int. Cl. B25B 21/02; B25B 23/14

(52) U.S. Cl. CPC B25B 21/02; B25B 23/1405
USPC 173/1; 173/181; 173/2

(57) ABSTRACT

An impact wrench which includes an air motor and a main shaft that is rotated by pulsed impact torque that is converted from rotary torque from the air motor to tighten a bolt, is provided with a torque sensor that detects a tightening torque on the bolt, and a controller that performs control functions to tighten the bolt, and the controller changes the rotational speed of the air motor to tighten up the bolt when the tightening torque that is detected by the torque sensor becomes equal to or higher than a prescribed value.

### BACKGROUND OF THE INVENTION

1. Field of the Invention

The present invention relates to a technology for an impact tightening tool that is used to tighten a screw or the like, and, more particularly, to a technology for tightening control of an impact tightening tool.

2. Description of the Related Art

Impact wrenches as impact tightening tools that are used to tighten a screw such as a bolt or nut are conventionally known. An impact wrench tightens a screw by applying pulsed torque to a main shaft to rotate the main shaft. Japanese Patent Application Publication No. 2009-113132 (JP-A-2009-113132) discloses an impact wrench which includes a torque sensor and an angle sensor and which determines the completion of screw tightening based on a reference torque range and a reference rotational angle range that are detected by the torque sensor and the angle sensor, respectively.

However, when the base materials to be joined are misaligned or when a foreign object is in a space between the screw and a base material, the level of the torque that is detected by the torque sensor may temporarily reach a prescribed reference torque range even if the bolt is not tightened properly, such as when the bolt is not appropriately seated on the base material. In other words, an impact wrench, such as the one that is disclosed in JP-A-2009-113132, may determine that screw tightening is completed even if the screw is not tightened properly.

### SUMMARY OF THE INVENTION

The present invention provides an impact tightening tool which can ensure proper tightening of a screw.

A first aspect of the present invention relates to an impact tightening tool which includes a rotary drive source and a main shaft that is rotated by pulsed impact torque that is converted from rotary torque from the rotary drive source to tighten a screw. The impact tightening tool includes a torque detection portion that detects a tightening torque on the screw, and a control portion that performs control functions to tighten the screw. The control portion changes the rotational speed of the rotary drive source to tighten up the screw when the tightening torque that is detected by the torque detection portion becomes equal to or higher than a prescribed value.

The control portion may reduce the rotational speed of the rotary drive source to tighten up the screw when the tightening torque that is detected by the torque detection portion becomes a prescribed value or higher.

The impact tightening tool according to the first aspect of the present invention can ensure proper tightening of a screw.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a partial cross-sectional view that illustrates the configuration of an impact wrench according to an embodiment of the present invention;

FIG. 2 is a block diagram that illustrates the control configuration of the impact wrench;

FIG. 3 is a flowchart that shows the flow of the tightening control of the impact wrench; and

FIG. 4 shows a graph that shows the relationship between the impact and torque and a graph that shows the relationship between the impact and the rotational speed.

### DETAILED DESCRIPTION OF THE PREFERRED EMBODIMENTS

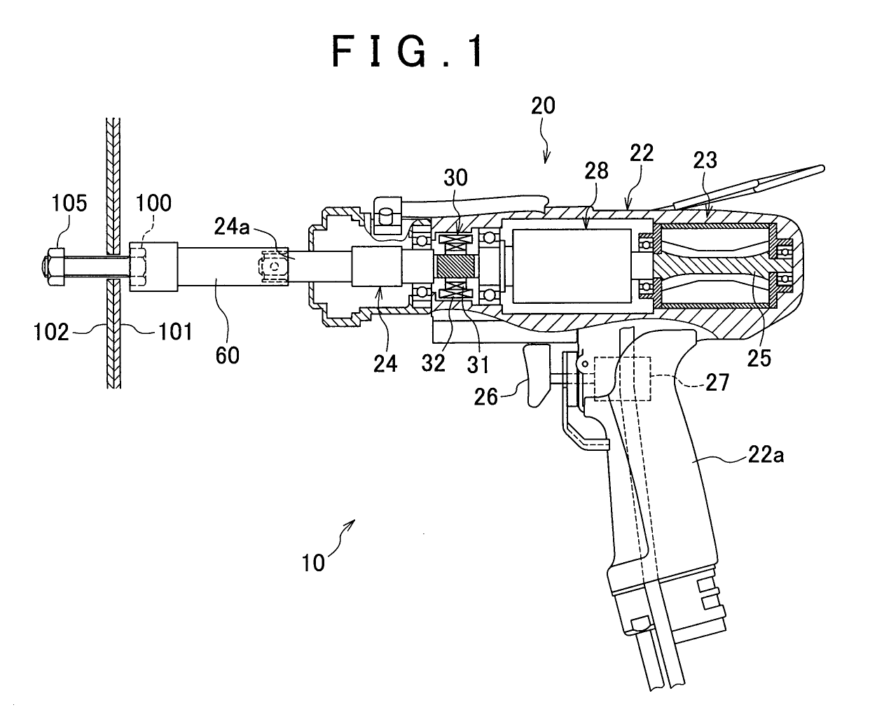

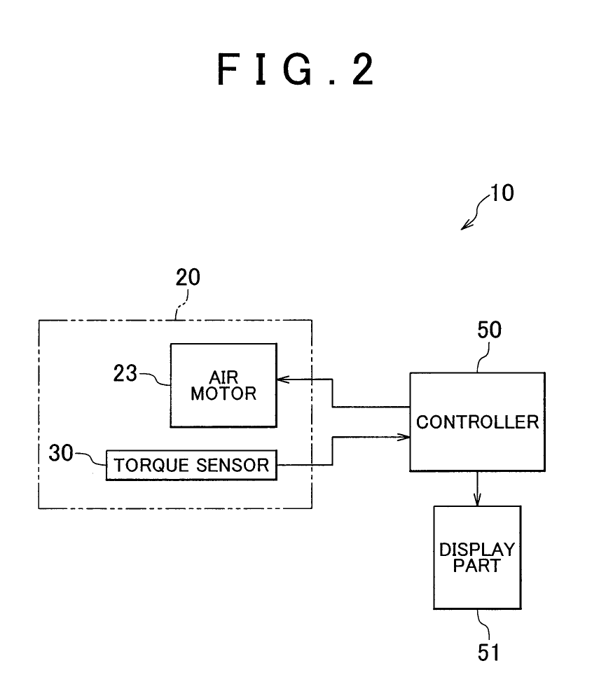

Description is hereinafter made of an impact wrench 10 as an impact tightening tool with reference to FIG. 1 and FIG. 2. As shown in FIG. 1, the impact wrench 10 is a tool that is used, when a base material 101 and a base material 102 are joined with a bolt 100 and a nut 105, to tighten the bolt 100 as a screw. The impact wrench 10 has a tool body 20, and a controller 50 (refer to FIG. 2) as control portions. The tool body 20 is provided with an air motor 23 as a rotary drive source, a main shaft 24, and an impact torque generator 28 in a housing 22. The housing 22 has a grip portion 22a. An electric motor may be used instead of the air motor 23.

The air motor 23 is provided with a rotor 25 which generates rotary torque with high-pressure air. The main shaft 24 is an output shaft in the tool body 20, and is rotatably supported by the housing 22. The main shaft 24 has an end portion 24a which protrudes from the housing 22 and is engageable with the bolt 100 via an attachment 60. The impact torque generator 28 is a device that converts continuous rotary torque from the air motor 23 into pulsed impact torque. The pulsed impact torque that is converted by the impact torque generator 28 is transmitted to the main shaft 24 and rotatably drives the main shaft 24.

The air motor 23 in this embodiment is configured to be rotated at two rotational speeds V (rotational speed V1 or rotational speed V2). Here, the rotational speed V2 is higher than the rotational speed V1. It should be noted that the number of the rotational speeds V is not necessarily limited to two but may be three or more in the present invention.

The grip portion 22a of the housing 22 is provided with an operation lever 26 and a main valve 27. The operation lever 26 is operatively connected with the main valve 27, and is used to control the supply and interruption of high-pressure air to the rotor 25. The main valve 27 allows and interrupts the supply of high-pressure air to the rotor 25 in response to the movement of the operation lever 26.

With this configuration, the continuous rotary torque from the air motor 23 is converted into pulsed impact torque on the main shaft 24. The impact torque tightens the bolt 100 via the attachment 60. In other words, the main shaft 24 is rotatably driven by the impact torque that is transmitted from the impact torque generator 28. Then, the bolt 100 that is coupled to the main shaft 24 via the attachment 60 is tightened by the rotary drive force of the main shaft 24.

The tool body 20 is provided with a torque sensor 30 as tightening torque detection portions. The torque sensor 30 is a sensor that detects the tightening torque on the bolt 100. The torque sensor 30 is located in the housing 22, and is constituted as a magnetostrictive sensor that has an exciting coil 31 which is provided to rotate around a prescribed portion of the main shaft 24, and a detection coil 32.

As shown in FIG. 2, the air motor 23, the torque sensor 30, and a display part 51 are connected to the controller 50. The controller 50 controls the tightening operation of the impact wrench 10. The controller 50 also has a function of selecting and setting the rotational speed V (rotational speed V1 or rotational speed V2) of the air motor 23. The display part 51 displays, for example, the tightening torque T that is detected by the torque sensor 30, the result of tightening failure detection, and so on.

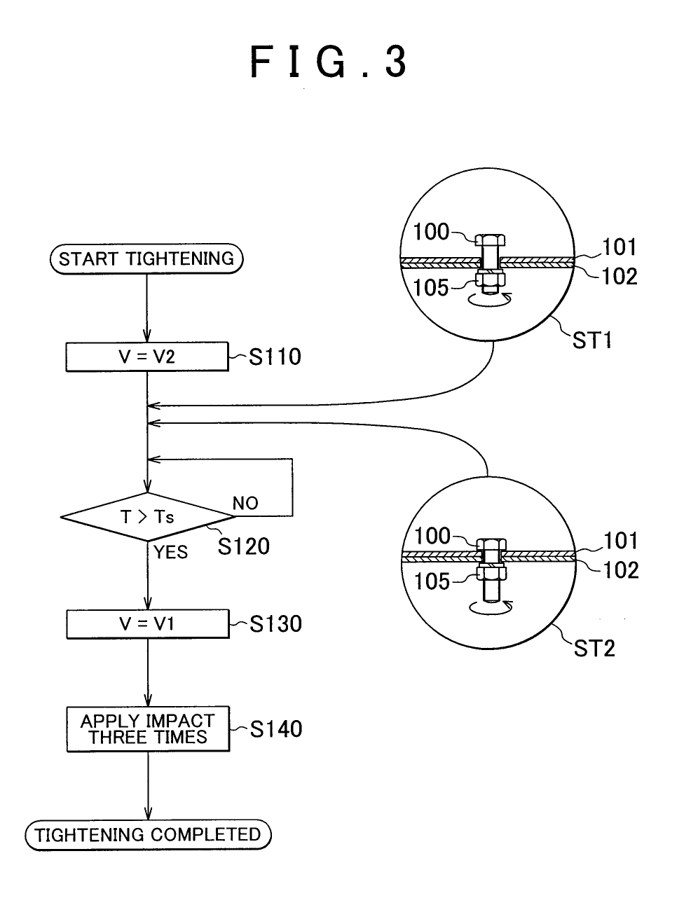

Referring to FIG. 3, the tightening control in the impact wrench 10 is described. In step 110, the controller 50 sets the rotational speed V of the air motor 23 to the rotational speed V2 and rotates the main shaft 24. Here, as shown in stage ST1, the state from the time when the operation lever 26 is turned ON to the time when the bolt 100 is seated on the base material 101 is referred to as “free running state.” In the free running state, no torque has been generated in the impact wrench 10 because the bolt 100 is threaded into the nut 105. Then, torque is generated in the impact wrench 10 after the bolt 100 is seated on the base material 101 as shown in stage ST2. The impact wrench 10 starts tightening up using impact torque when the torque is generated.

In step S120, the controller 50 checks the tightening torque T that is detected by the torque sensor 30 and determines whether or not the tightening torque T is greater than a reference tightening torque Ts. Here, the reference tightening torque Ts is a tightening torque which has been preliminarily set in the controller 50 and is used as a reference to determine that the tightening of the bolt 100 is completed. If the tightening torque T is greater than the reference tightening torque Ts, the routine proceeds to step S130. If the tightening torque T is not greater than the reference tightening torque Ts, the tightening is continued.

In step 130, the controller 50 changes the rotational speed V of the air motor 23 from the rotational speed V2 to V1 to set the rotational speed V to V1. In step 140, the controller 50 tightens up the bolt 100 by applying an impact torque three times and completes the tightening operation.

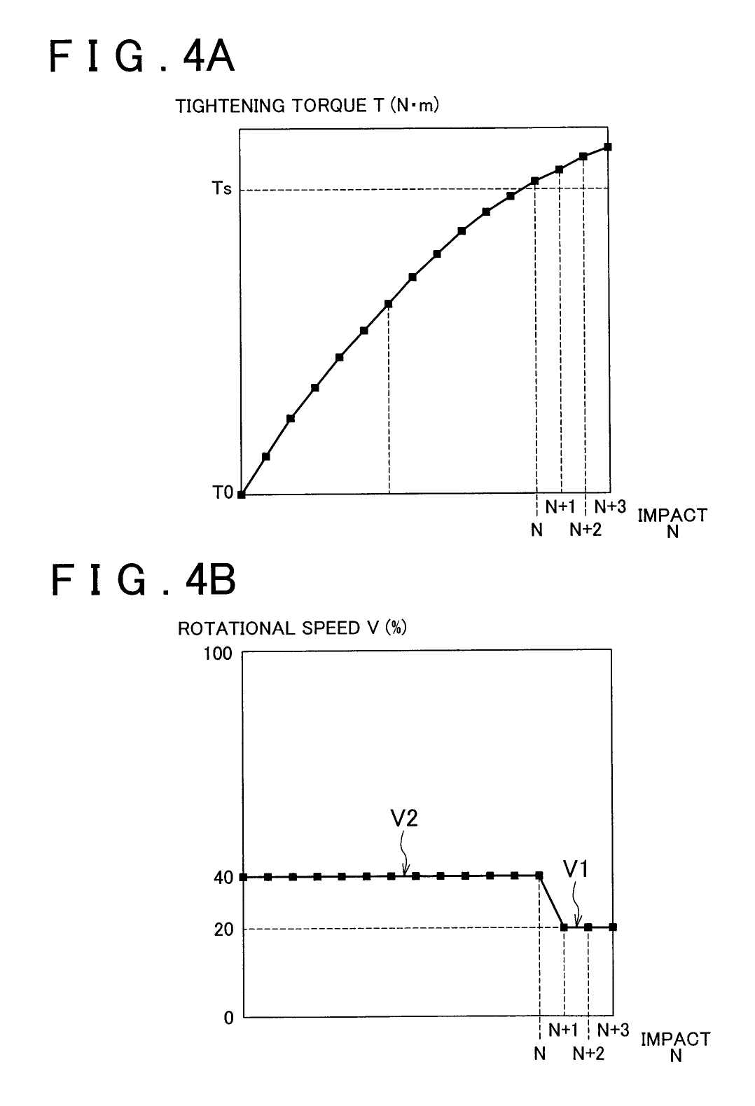

Referring to FIG. 4, the relationship between the impact N and the tightening torque T and the relationship between the impact N and the rotational speed V at a time when the bolt 100 is tightened with the impact wrench 10 are described. The graph in FIG. 4A shows the relationship between the impact N and the tightening torque T at a time when the bolt 100 is tightened with the impact wrench 10. The relationship in the free running state is not shown. Thus, the start torque T0 is the torque which is generated when the bolt 100 is seated on the base material 101.

The graph in FIG. 4B shows the relationship between the impact N and the rotational speed V at a time when the bolt 100 is tightened with the impact wrench 10. Here, the rotational speed V is shown as the percentage relative to the maximum rotational speed of the air motor 23, which is taken as 100%. In this embodiment, the maximum rotational speed of the air motor 23 is 4000 rpm.

The tightening torque T increases from the start torque TO with increase of impact N. When the impact at which the tightening torque T exceeds the reference tightening torque Ts for the first time is defined as impact N, the bolt 100 is tightened up by the next impact N+1 to the third impact N+3 before the completion of the tightening operation. On the other hand, the rotational speed V is maintained at the rotational speed V2 to tighten the bolt 100 while the tightening torque T increases from the start torque T0 to a value which is greater than the reference tightening torque Ts. Then, the rotational speed V is maintained at the rotational speed V1 to tighten up the bolt 100, while from the impact N+1, which follows the impact N at which the tightening torque T exceeds the reference tightening torque Ts for the first time, to the third impact N+3 are applied.

In this embodiment, the rotational speed V2 is 40% (1600 rpm) of the maximum rotational speed of the air motor 23, and the rotational speed V1 is 20% (800 rpm) of the maximum rotational speed of the air motor 23.

The advantages of the tightening control are described. In an impact wrench, the impacts are usually stronger as the rotational speed of the air motor or electric motor is higher. When tightening is carried out with strong impacts, the tightening time can be reduced but the tightening accuracy decreases. On the contrary, when tightening is carried out with weak impacts, the tightening time increases but the tightening accuracy can be improved.

Therefore, in this embodiment, it is determined that tightening of the bolt 100 is almost completed when the tightening torque T exceeds the reference tightening torque Ts and the bolt 100 is tightened up with weaker impacts thereafter. Thus, if the bolt 100 has been properly tightened in reality when it is determined that tightening of the bolt 100 is almost completed, the bolt 100 is not further tightened so much. On the contrary, if the bolt 100 has not been properly tightened in reality when it is determined that tightening of the bolt 100 is almost completed, the bolt 100 can be further tightened even with weaker impacts. Thus, the bolt 100 can be properly tightened up with high tightening accuracy.

In general, an impact wrench is provided with an angle sensor that detects the rotational angle of the main shaft and is configured to determine the completion of screw tightening based on the rotational angle of the main shaft that is detected by the angle sensor. In this embodiment, however, it is determined, using only the torque sensor 30, that tightening of the bolt 100 is almost completed when the tightening torque T exceeds the reference tightening torque Ts. Then, if the bolt 100 is not properly tightened in reality, a weaker impact is applied three times to ensure the reliability against insufficient tightening of the bolt 100. In this configuration, the angle sensor of the impact wrench 10 can be omitted.

In this embodiment, the rotational speed is reduced by reducing the rotational speed V of the air motor 23 from the rotational speed V2 to V1 in step 130. However, the present invention is not limited to reducing the rotational speed. For example, if the nut 105 is tightened with the impact wrench 10 when the base material 101 and the base material 102 are joined by the bolt 100 and the nut 105, the nut 105 can be properly tightened up by increasing the rotational speed V in contrast to this embodiment.

In addition, there may be a case where the screw holes of the base material 101 and the base material 102 and the bolt 100 which have precise roundness are perfectly aligned with each other when the base material 101 and the base material 102 are joined by the bolt 100 and the nut 105. In this case, the bolt 100 can be properly tightened up by applying weaker impacts until the tightening torque T exceeds the reference tightening torque Ts and then increasing the rotational speed V in contrast to this embodiment.

In an electric motor, the driving current is usually proportional to the rotational load. Thus, in a different embodiment from this embodiment, the air motor 23 is replaced by an electric motor. In this case, the reference for completion of tightening can be determined by determining whether the driving current in the electric motor is greater than a prescribed current value instead of determining whether the tightening torque T is greater than a reference tightening torque Ts as in step S120 in this embodiment. In this configuration, the torque sensor 30 of the impact wrench 10 can be omitted.

1. An impact tightening tool which includes a rotary drive source and a main shaft that is rotated by pulsed impact torque that is converted from rotary torque from the rotary drive source to tighten a screw, the impact tightening tool comprising:
a torque detection portion that detects a tightening torque on the screw; and
a control portion that performs control functions to tighten the screw,
wherein the control portion changes a rotational speed of the rotary drive source to tighten up the screw when the tightening torque that is detected by the torque detection portion becomes equal to or higher than a prescribed value, and
wherein the prescribed value is a tightening torque that is used as a reference to determine that a tightening of the screw is completed.

2. The impact tightening tool according to claim 1,
wherein the control portion reduces the rotational speed of the rotary drive source to tighten up the screw when the tightening torque that is detected by the torque detection portion becomes the prescribed value or higher.

3. An impact tightening tool which includes a rotary drive source and a main shaft that is rotated by pulsed impact torque that is converted from rotary torque from the rotary drive source to tighten a screw, comprising
a control portion that performs control functions to tighten the screw,
wherein: the rotary drive source is an electric motor, and the control portion changes a rotational speed of the rotary drive source to tighten up the screw when the driving current in the electric motor becomes equal to or higher than a prescribed current value; and
wherein the prescribed current value is a driving current that is used as a reference to determine that a tightening of the screw is completed.

4. A tightening method of a screw with a tightening tool, the tightening tool including a rotary drive source and a main shaft that is rotated by pulsed impact torque that is converted from rotary torque from the rotary drive source to tighten the screw, the tightening method comprising:
detecting a tightening torque on the screw; and
tightening the screw, when the tightening torque becomes equal to or higher than a prescribed value, by changing a rotational speed of the rotary drive source, the prescribed value being a tightening torque used to determine that a tightening of the screw is completed.

5. The tightening method of the screw according to claim 4, further comprising reducing the rotational speed of the rotary drive source when the tightening torque becomes the prescribed value or higher.
